(19) United States
(12) Patent Application Publication
(10) Pub. No.: US 2025/0198481 A1
(43) Pub. Date: Jun. 19, 2025

(54) DRAWSTRING CLIP

(71) Applicant: Ryan Volk, Saskatoon (CA)

(72) Inventor: Ryan Volk, Saskatoon (CA)

(21) Appl. No.: 18/980,801

(22) Filed: Dec. 13, 2024

Related U.S. Application Data
(60) Provisional application No. 63/609,580, filed on Dec. 13, 2023.

(51) Int. Cl. F16G 11/14

(52) U.S. Cl. CPC F16G 11/143

(57) ABSTRACT

An apparatus an method for for securing drawstrings wherein the apparatus comprises a body extending between first and second ends and formed of a pair of spaced apart central members connected to each other at the first end, a pair of side members connected to the central members at the second end and a pair of outside members connected to the side members at the first end. The central members form a central slot therebetween extending from the first end and the side members each form a side slot with its corresponding outside member extending from the second end. The method comprises passing the drawstrings through each of the two side slots in a first direction and passing the drawstrings together through the central slot.

### BACKGROUND

### 1. Technical Field

This disclosure relates generally to clothing accessories and in particular to a method and apparatus for securing loose ends of drawstrings of clothing articles.

### 2. Description of Related Art

Many clothing articles include drawstrings for selectably closing hoods, tightening waists or the like. Such drawstrings frequently include a length of string, rope, elastic or other elongate flexible material that is passed through a loop or eyelet in the ends of the clothing item. Optionally the drawstring may be threaded through a hem or a tube of material and passed out thereof through openings or eyelets. The ends of the drawstring are used to reduce the diameter of the tube or hem of the article of clothing or to secure the article of clothing around an object or body part of the wearer.

In practice many drawstrings extend to free distal ends as opposed to being formed of a continuous loop. The ends of such drawstrings are frequently provided with a knot, hard sleeve or other end treatment to facilitate grip and reduce fraying of the ends of the drawstring. Disadvantageously, as drawstrings may often be untied or left loose, during washing or drying the strings may be pulled from one direction or a middle portion so as to retract one free distal end of the drawstring into the hem or within the clothing. Such retracted draw strings can be difficult to rethread through the hem, especially if the ends have become frayed.

### SUMMARY OF THE DISCLOSURE

According to a first embodiment of the present disclosure, there is provided an apparatus for for securing drawstrings comprising a body extending between first and second ends and formed of a pair of spaced apart central members connected to each other at the second end, a pair of side members connected to the central members at the first end and a pair of outside members connected to the side members at the second end. The central members form a central slot therebetween extending from the second end and the side members each form a side slot with its corresponding outside member extending from the first end.

The spaced apart central members are connected with a central block at the second end thereof. The central block has an arcuate shape. The central block is formed continuous with ends of the central members. The central slot has a widest portion proximate to the central block. The central slot narrows proximate to the first end.

The side members are connected to and extend from the central members at the first end. The side members extend in a direction towards the central block. The side slots include a narrowed entrance proximate to the central block.

The side slot include widened portion defined in part by a wall extending away from a length of the side slots. The wall extends substantially perpendicular to a length of the side slots. The wall forms an edge with a surface of at least one of the central member and the side member. The widened portion is formed into the outside member. The wall tapers to the outside member an end distal from the central block.

The outside members include a tab at the first end. The apparatus is substantially planar.

According to a further embodiment of the present disclosure, there is provided a method for securing drawstrings in an article of clothing comprising providing a body formed of a body extending between first and second ends and formed of a pair of spaced apart central members connected to each other at the second end, a pair of side members connected to the central members at the first end and a pair of outside members connected to the side members at the second end wherein the central members form a central slot therebetween extending from the first end, and wherein the side members each form a side slot with its corresponding outside member extending from the first end. The method further comprises passing the drawstrings through each of the two side slots in a first direction and passing the drawstrings together through the central slot.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a top plan view of the drawstring clip according to a first embodiment of the present disclosure. Pa

FIG. 2 is a top view of the drawstring clip of FIG. 1 having a drawstring threaded therethrough at a first position.

FIG. 3 is a top view of the drawstring clip of FIG. 1 having a drawstring threaded therethrough at a second position.

### DETAILED DESCRIPTION

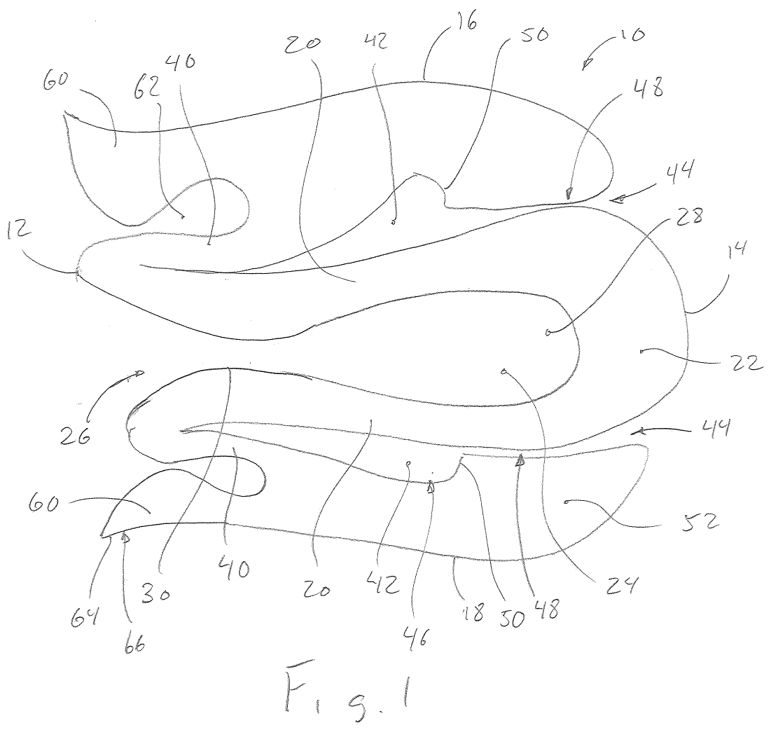

Aspects of the present disclosure are now described with reference to exemplary apparatuses, methods and systems. Referring to FIG. 1, an exemplary apparatus for securing drawstrings 8 according to a first embodiment is shown generally at 10. The body 10 comprises a plurality of members forming a central slot 24 extending from one end adapted to receive both ends of the drawstring and a pair of side slots 42 extending from an opposite end adapted to receive one of each drawstring therein. The body 10 extends between first and second ends, 12 and 14, respectively and first and second side edges, 16 and 18, respectively. As illustrated, the body 10 may be substantially flat, although other shapes and profiles may also be utilized.

The body 10 is formed of a pair of spaced apart central members 20 extending between the first and second ends 12 and 14. The central members 20 extend to and are integrally connected with a central block 22 at the second end 14 and are spaced apart and unconnected from each other at the first end. In such a manner the central members form the central slot 24 therebetween. As illustrated, the central block 22 is thicker than the central members so as to be substantially non-flexible relative to the central members 20. In operation, any forced applied thereto will result in deformation or bending of the central members 20 instead of the central block.

The central slot 24 includes an entrance section 26 extending from the first end 12 and a widened bottom section 28 proximate to the central block with a narrowed throat section 30 therebetween. The bottom section 28 forms an opening sized to receive two lengths of drawstring therein wherein the throat section is narrowed to prevent free removal of drawstrings therefrom. In particular the throat section may be sized to have a gap therebetween less than the thickness of each drawstring.

The body 10 further includes a pair of side members 40 extending between first and second ends 12 and 14 of the body. Each side member 40 is connected to a corresponding central member 20 at the first end 12 and spaced apart from its corresponding central member 20 at the second end. Each side member 40 forms the side slot 42 between the side member and its corresponding central member. Each side slot 42 includes an entrance portion 44 proximate to the second end 14, a widened bottom portion 46 proximate to the first end 12 and a throat portion 48 therebetween. The bottom portion 46 includes an opening sized to receive one portion of the draw string therein and is therefore smaller than the bottom section 28 of the central slot. The bottom portion 46 may also include a return wall 50 curved and optionally angled back towards the first end 12 before the throat 48. The return wall 50 assist with retaining the drawstring within the bottom portion 46.

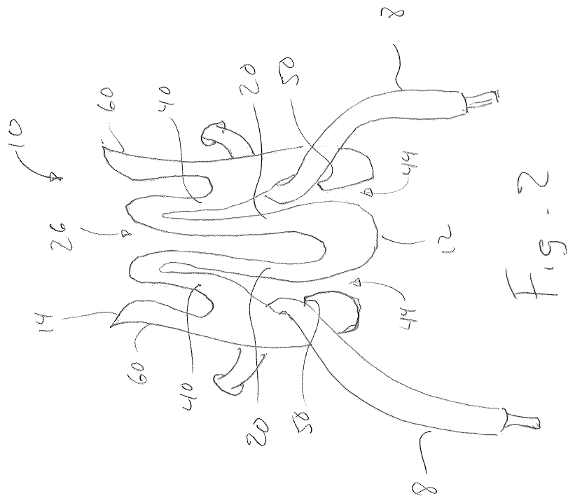

As illustrated, proximate to the second end 14, the side members 40 may be substantially thicker than proximate to the first end 12 and may form side blocks 52. The side blocks 52 prevent deformation or bending of the side members 40 proximate to the second end 14 and thereby retain the bending of the side members proximate to the first end 12. Furthermore, as illustrated in FIG. 2, the central members 30 proximate to the first end are also thinner than the side members at a similar location. Accordingly, any force applied to the tabs 64 as will be described below will therefor deform the central members 20 more than the side members and will accordingly move the return wall 50 away from the central members 20 so as to open the side slots 42 for removal of the drawstrings.

The body 10 also includes outside members 60 extending from the side members 40 towards the first end 12. The outside members are separated from the side members 40 by relief slots 62 and extend to a distal end tab 64. The end tabs 64 are angled away from the body so as to provide a surface 66 on which a user may apply a force to spread the side slots for removal of the drawstrings therefrom.

The body 10 may be formed of any desired material including without limitation, plastics, metals, composite materials and construction methods including injection moulding, additive manufacturing, casting or machining. The body 10 may be formed of a continuous body or may optionally be formed in multiple parts. Furthermore, as illustrated in the figures, the body 10 including the central members 20, side members 40 and outside members 60 may be substantially co-planar with each other. The body 10 including the central members 20, side members 40 and outside members 60 may have any desired cross section including, without limitation, round, square and irregular although it has been found that utilizing parallel edges for the slots and in particular the widened portion and wall 50 may assist with retaining the drawstring 8 therein and preventing slipping thereouth.

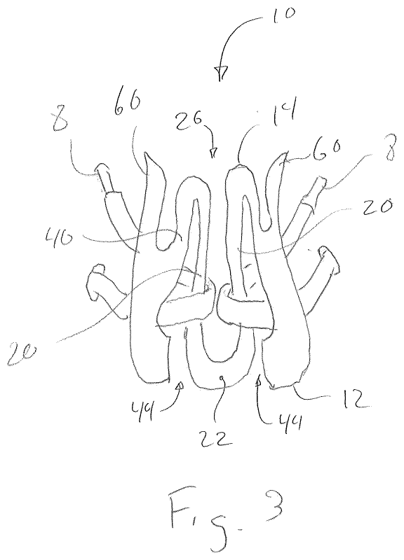

In operation, as illustrated in FIG. 2, one length or side of the drawstring 8 may be passed into each of the side slots 44 and thereafter both lengths passed together into the central slot 26 so as to retain the two drawstring lengths together as illustrated in FIG. 3.

While specific embodiments have been described and illustrated, such embodiments should be considered illustrative only and not as limiting the disclosure as construed in accordance with the accompanying claims.

What is claimed is:

1. An apparatus for for securing drawstrings comprising:
a body extending between first and second ends and formed of a pair of spaced apart central members connected to each other at the second end;
a pair of side members connected to the central members at the second end; and
a pair of outside members connected to the side members at the second end,
wherein the central members form a central slot therebetween extending from the second end, and
wherein the side members each form a side slot with its corresponding outside member extending from the second end.

2. The apparatus of claim 1 wherein the spaced apart central members are connected with a central block at the second end thereof.

3. The apparatus of claim 2 wherein the central block has an arcuate shape.

4. The apparatus of claim 3 wherein the central block is formed continuous with ends of the central members.

5. The apparatus of claim 1 wherein the central slot has a widest portion proximate to the central block.

6. The apparatus of claim 5 wherein the central slot narrows proximate to the second end.

7. The apparatus of claim 1 wherein the side members are connected to and extend from the central members at the second end.

8. The apparatus of claim 7 wherein the side members extend in a direction towards the central block.

9. The apparatus of claim 1 wherein the side slots include a narrowed entrance proximate to the central block.

10. The apparatus of claim 9 wherein the side slot include widened portion defined in part by a wall extending away from a length of the side slots.

11. The apparatus of claim 10 wherein the wall extends substantially perpendicular to a length of the side slots.

12. The apparatus of claim 11 wherein the wall forms an edge with a surface of at least one of the central member and the side member.

13. The apparatus of claim 10 wherein the widened portion is formed into the outside member.

14. The apparatus of claim 13 wherein the wall tapers to the outside member an end distal from the central block.

15. The apparatus of claim 1 wherein the outside members include a tab at the second end.

16. The apparatus of claim 1 wherein the apparatus is substantially planar.

17. A method for securing drawstrings in an article of clothing comprising:
providing a body formed of:
a body extending between second and second ends and formed of a pair of spaced apart central members connected to each other at the first end;
a pair of side members connected to the central members at the first end; and
a pair of outside members connected to the side members at the second end,
wherein the central members form a central slot therebetween extending from the second end, and
wherein the side members each form a side slot with its corresponding outside member extending from the first end;
passing the drawstrings through each of the two side slots in a first direction; and
passing the drawstrings together through the central slot in a second direction.
